(19) United States
(12) Patent Application Publication
(10) Pub. No.: US 2026/0027769 A1
(43) Pub. Date: Jan. 29, 2026

(54) Metal Plating of 3D Objects Printed with Catalyst Precursor Resin

(71) Applicant: Elektrum Technologies, Inc., Denton, TX (US)

(72) Inventor: Yieu Chyan, Denton, TX (US)

(73) Assignee: Elektrum Technologies, Inc., Denton, TX (US)

(21) Appl. No.: 19/279,437

(22) Filed: Jul. 24, 2025

Related U.S. Application Data
(60) Provisional application No. 63/675,048, filed on Jul. 24, 2024.

(51) Int. Cl. B29C 64/124; B33Y 10/00; B33Y 70/10; B33Y 80/00; C23C 18/31

(52) U.S. Cl. CPC B29C 64/124; C23C 18/31; B33Y 10/00; B33Y 70/10; B33Y 80/00

(57) ABSTRACT

A method of generating metal-coated three-dimensional (3D) parts using particle-free resin containing a catalyst precursor that subsequently forms catalytic seed nanoparticles in-issue during or after a 3D printing or forming step. The reductant is selected to minimize particle generation under ambient conditions but the reduction of the catalyst precursors in the ink may be accelerated by an external input such as heat or ultraviolet (UV) energy. The activated object containing metal nanoparticles is then plated using a suitable electroless chemistry to yield a composite 3D object with one or more metal surfaces. Etching of the polymer matrix may be employed to obtain a metal object.

### CROSS-REFERENCE TO RELATED APPLICATION(S)

This application claims the benefit of U.S. Provisional Application No. 63/675,048, filed Jul. 24, 2024, the disclosure of which is incorporated herein by reference as if set forth in full.

### TECHNICAL FIELD

The present invention relates to the use of metal-particle-free resins containing electroless plating catalyst precursors to fabricate 3D objects by means such as stereolithography (SLA) printing. Catalytic sites are then generated in-situ followed by electroless plating to deposit metal on the 3D printed object to yield one or more metal surfaces.

### BACKGROUND OF THE INVENTION

Existing methods for metal 3D printing such as selective laser sintering, binder jetting, and metal filament extrusion are often more suited for bulk scale printing. One significant limitation to these existing techniques is that they involve the use of metal powders or filaments which are then fused together. The diameters of the existing metal powders or filament necessarily limit the resolution of the finished part. Aggregations and clumping of these powders can also limit the practical resolution that is possible. A method of more easily making micron-scale metal or metal-composite materials would be particularly desirable.

### SUMMARY OF THE INVENTION

There are many potential applications for high resolution printing of three-dimensional objects with metallic components. These include electrodes for fuel cells, micro-supercapacitors, biomechanical devices, lab-on-a-chip, batteries, and any other device where a conductive electrode with a high surface area-to-volume ratio and/or complex 3D shape might be desirable. Heat exchange devices such as coolers for microelectronics are another potential application as well as lightweight metal foams and composites that display high strength to weight ratios. Additionally, micro-molds or stamps could be manufactured in a resin material and then hardened using electroless plating to yield a more robust and durable component. Yet another potential application could be the manufacture of metallic or composite micro-lattice materials which have very high strength to weight ratios.

The invention is a method of making 3D structures that are least partially comprised of metal particle-free catalytic precursor resins which are then converted to active catalysts and metalized with electroless plating. Optional use of non-catalytic resins in addition to catalytic resins may be used to generate a 3D object that may be selectively metal plated only in areas containing catalyst or catalyst precursors. The preferred embodiment of the present disclosure is a self-reducing metal particle-free resin that contains a reductant and/or initiator carefully selected to minimize reduction of the metal ions during storage of the resin, but which can be subsequently activated to yield catalytic metal particles. The resin may be patterned and cured into a 3D shape by any method of 3D printing involving the curing or hardening of a liquid or semi-liquid resin such as stereolithography. Typically, this would mean UV-curing by exposure of a UV-sensitive resin since these resins tend to have the fastest curing times. This embodiment is particularly suitable for precursor resins that generate catalytic particles (such as particles of copper and to a less extend particles of silver) that are subject to oxidation that may reduce the catalytic activity of the particles.

Another embodiment is a self-reducing metal particle-free resin composition where the reductant and/or initiator are selected to cure or partially cure the resin and reduce the reducible metal ions or complexes under similar conditions. The resin would cure into the 3D shape and the catalyst precursors would be reduced into catalytic particles simultaneously. This allows for a reduction in the number of process steps required and may be most suitable for generating catalytic nanoparticles that are not expected to oxidize in the time-period between the patterning and plating steps. Similarly to the previous embodiment, the resin may be patterned and cured into a 3D shape by any method of 3D printing involving the curing or hardening of a liquid or semi-liquid resin such as stereolithography.

A third embodiment involves the casting or molding of resins containing catalytic precursors into a mold or using another patterning device. This may include extrusion, injection molding, vacuum casting, thermoforming or any other suitable method. This embodiment is particularly suitable for larger objects where the resolution and dimensional accuracy of the object may not be as critical. This is distinguished from other potential methods of casting followed by plating in that generating fresh nanoparticles in-situ may allow for the replacement of noble metal catalysts with cheaper catalysts such as copper without being affected by oxidation of copper particles in the resin before the object can be cast and plated.

### BRIEF DESCRIPTION OF THE DRAWINGS

FIG. 1 is an illustration of steps involved in stereolithography 3D printing of an object using a particle-free catalyst precursor resin that is subsequently cured and catalytic nanoparticles generated in-situ. Plating the external surface of the yields a structure with a metallic exterior surface coating.

FIG. 2 is an illustration of steps involved in generating a catalytic 3D printed object with an internal cavity. Plating the internal cavity can result in a metal-lined chamber. Optional etching of the polymer yields a thin-walled metallic object.

FIG. 3 is a flow chart for a method of implementing the usage of metal particle-free resins wherein catalytic particle generation step occurs separately from the resin curing step and preferably close in time to the plating step.

### DETAILED DESCRIPTION

Recently, electroless plating of polymer 3D objects produced by vat-photopolymerization of UV-curable (ultraviolet) resins has been used to make metal-coated parts. The most common current approach for metallizing a polymer object uses various surface treatments that can include etching with chromic acid followed by depositing palladium seeds for electroless plating. There are both environmental and cost concerns with this method. Other approaches involve direct addition of catalytic metal salts, metal nanoparticles, or metal nanoparticles adsorbed to some carrier material to the UV resin. All of these approaches have various limitations including availability of catalytic sites near the surface, cost, adhesion of the metal layer to the surface of the 3D printed resin object, scattering of the UV light used to cure the layers during printing, and potential resolution limitations due to aggregations of particles.

Catalytic inks have been used in 2D applications where a catalytic precursor or catalyst nanoparticles may be used to generate a first pattern that is then plated to obtain a conductive shape or pattern. These 2-dimensional patterns consisting of a catalytic precursor ink are frequently generated by methods such as flexography, inkjetting, offset printing, gravure printing, or screen printing. In other cases, these patterns may be generated by lithographic methods such as photolithography or nanoimprint lithography. The distinction is that the thickness of the ink pattern does not substantially exceed the thickness of the substrate that it is printed on. Moreover, a 3D print is distinguished from a 2D print in terms of the number of layers that are stacked on top of each other. In a 2D print, the mechanical support for the ink pattern or patterns are primarily derived from the substrate surface whereas in a 3D print there are usually some layers of the print that are not directly attached to a substrate surface but rather are adhered to and supported by preceding layers. This will likely require resins that are tuned differently in terms of viscosity, curing rate, and other properties compared with inks intended for 2D printing.

The enhanced techniques herein improve the making of micron-scale metal or metal-composite materials.

A metal particle-free resin may contain a mixture of monomers, oligomers or polymers, metal elements, metal complexes, organometallics, in a solid or liquid state. In some embodiments, the concentration of the reducible metal ion, organometallics or metal complexes ranges from 0.1 wt. %-25 wt. %, preferably from 0.5 wt. %-5 wt. %. In some embodiments, the source of these reducible metal ions may be a metal compound such as a salt. Some preferred metals include silver, copper, and nickel. For copper, the metal compound can be a copper (I) compound, a copper (II) compound, or a combination of a Cu (I) and Cu (II) compound. Examples of suitable copper salts include but are not limited to copper sulfate, copper nitrite, copper formate, copper bromide, copper trifluoroacetate, copper acetate, or copper chloride. For silver, metal compounds that are silver (I) compounds are preferred. Example silver salts include but are not limited to silver nitrate, silver perchlorate, silver tetrafluoroborate, silver triflate, silver hexafluorophosphate, silver carbonate, and silver acetate. An appropriate metal compound should be selected based on solubility in the solvents or other components used in the resin. For nickel, useful metal salts may include but are not limited to nickel acetate, nickel formate, nickel chloride, or nickel sulfate. Other suitable salts or compounds of catalytic metals such as gold, nickel, iridium, rhodium, platinum, or palladium may be used.

Metal particle-free means that the majority of the metallic catalyst is initially added to the formulation in the form of reducible metal ions rather than metal particles or nanoparticles. These metal ions may be added in the form of an organometallic or metal complex or in the form of metal salts. Particle-free does not refer to the intentional addition of particles other than catalytic metal particles, especially transparent particles with a similar refractive index to the other resin components. In one embodiment, a “particle-free” resin is one that has preferably less than 0.5% particles. In another embodiment, a “particle-free” resin is one that has less than 1% particles. While reduction of ions may occur during storage of the resin formulation, this is undesirable and may limit the useful lifespan of the resin since this can lead to agglomeration and uneven distribution of catalytic sites as well changes to viscosity.

A self-reducing metal nanoparticle catalyst precursor resin may include at least one monomer, polymer, or oligomer as well as any number of additives. An additive may refer to any component that may modify any number of the properties of the resin. A self-reducing resin is a composition that contains all the necessary components to form catalytic nanoparticles as printed. The reduction of the reducible metal ions, reducible organometallics, or metal ion complexes may be initiated by some external activation such as heat or UV energy but does not require the application of a second liquid in a process step after the patterning step. Depending on the metal, the resin formulation may contain a reductant if necessary to reduce metal ions to metal0. In some embodiments, the catalyst precursor may be a metal complex that decomposes to form metal nanoparticles. More noble metals such as Pd may not require a separate reductant but less noble metals such as Cu may require a separate reductant. A resin additive may be used to increase the permeability of the resin to water to increase the volume of the resin that contacts the aqueous plating solution. One example of such an additive may consist of a hydrophilic polymer. Initiation of metal plating from the interior of the resin may also improve interaction between the plated metal and the patterned resin.

A compound or functional group suitable for stabilizing the reducible metal ions by forming a metal complex may be used in certain embodiments. For example, ethylenediaminetetraacetic acid (EDTA) and tartaric acid are frequently used as a chelator for Cu in aqueous metal plating solutions. For nickel, exemplary non-nitrogen-based chelators include glycolic acid, malic acid, lactic acid, citric acid, tartric acid succinic acid and their sodium salts. Nitrogen based chelators include but are not limited to triethanolamine, ethylenediamine, aspartic acid, glycine, bipyridyl and EDTA. For copper, exemplary chelating agents include alkyl amines, aldimines, pyrazines, ammonia, amine-aldehyde condensates, alcohol amines, or combinations thereof. Examples of amines suitable for copper chelation include methylamine, ethylamine, triethanolamine, ethylenediamine, and EDTA. For silver, exemplary chelating agents include alkyl amines, aldimines, amine-aldehyde condensates, alcohol amines or combinations there. More specifically, this may include EDTA, diethylenetriamine, triethnolamine, Ethylene glycol-bis-(2-aminoethyl)-N,N,N′,N′-tetraacetic acid (EGTA), nitrilotriacetic acid, and triethanolamine.

For certain metals such as Ag but especially for Cu, the addition of one or more chemical reductants may be required to reduce the reducible metal ions, metal complexes, or organometallics. In some embodiments, this reducing agent may be selected from an alcohol, a polyol, an aldehyde, a dialdehyde, an amide, an imine, an aldimine, an oxime, an aldoxime, a formate, a hydrazine, a hypophosphite, dimethylamine borane or combinations thereof. The selection of the reducing agent should be tailored to the reduction potential of the metal and the strength of the chelator. For example, silver has a standard reduction potential of 0.7996V whereas copper has a standard reduction potential of 0.52V. A stronger reducing agent would be required for copper as compared to silver. Another example would be EDTA is a stronger chelating agent than tartrate and would require a stronger reducing agent if all other conditions were kept the same. In some embodiments examples of strong reducing agents may include an alkali metal hydride, a hydride complex of an alkali metal with boron, a hydride complex of an alkali metal with aluminum. Some examples of these include lithium hydride, lithium borohydride, sodium borohydride, and lithium aluminum hydride.

One embodiment includes the generation of 3D parts via stereolithography using a photocurable acrylate resin consisting of (a) monomers, oligomers, polymers or a combination thereof, (b) a catalytic precursor that comprises reducible ions of Ag, Cu, or Pd, (c) a chelating agent, (d) a photoinitiator and (e) optionally an appropriate reducing agent. Stereolithography is a method of 3D printing that involves making 3D objects in a layer-by-layer fashion by a photochemical process that crosslinks monomers, oligomers or polymers to solidify a photocurable resin. The specific wavelength that causes a photocurable resin to cure will depend on the selection of photoinitiator. UV-curable resins are most frequently used in stereolithography, but other light frequencies may be used where appropriate. Some example acrylates include but are not limited to epoxy acrylates, urethane acrylates, PEG acylates, aminated acrylates, and polyester acrylates. Polyethylene glycol (PEG) acrylates specifically may be used as an additive to tune the hydrophilicity of the resin composition. The photoinitiator may be selected to be sensitive to 365 nm UV light or 405 nm UV light typically used in existing commercial stereolithography 3D printers or to another wavelength if a different light source is used.

U.S. Pat. No. 6,365,415B1 (Li et al) describes the electroless plating of a hydrogel as the method of characterizing the size, size distribution, and spatial distribution of the pores of a porous substrate. This was used as an analytical technique of a prefabricated hydrogel pattern but not as part of a method of 3D printing a polymer-metal composite. A hydrogel is a material that consists of a water-swollen 3D polymer network often featuring tunable physicochemical properties. As compared with a typical 3D object printed using UV-resin, a hydrogel is a semi-solid material that may contain up to 90% or more water by weight. As a result, aqueous metal plating solutions may interact with a substantially larger volume of a 3D object compared with a non-hydrogel object. As such, it can be expected that the metal content of a composite material based on the plating of a catalytic hydrogel may be higher in terms of weight percentage as well as the plating depth. This is substantially different than the expected surface plating depth of a non-hydrogel object where plated metal is only expected to intact with a few to tens of microns of the plastic surface. Polymers that have been used to make hydrogels include biologically derived polymers including alginate, gelatin, hyaluronic acid, chitosan, heparin, and fibrin. Synthetic polymers used to make hydrogels include polyvinyl alcohol, polyethylene glycol, polyacrylate, polyacrylamides, polyvinylpyrrolidone and co-polymers thereof. Selective plating of hydrogel surfaces can be achieved by any method of selectively depositing catalyst containing polymers within the larger 3D printed object. Hydrogel composites may be useful for biosensors, smart contacts, and lab-on-a-chip applications among others.

If the metal content is sufficiently high in a given plated 3D object, pyrolysis in air, inert or reducing atmosphere may be employed to remove the polymeric matrix. It may be desirable to select polymers that pyrolyze as cleanly as possible to yield gaseous products to minimize carbon residues. Shrinkage of the object will be a function of the porosity and overall density of the metal in the plated 3D object. This can yield a solid metal object. Alternatively, the polymer scaffolding can be etched away. Polymers may be selected that are soluble in certain organic solvents but not in water such that the structure is maintained during the electroless plating but can be later removed. Polymers can also be selected to have functional groups that can increase solubility upon treatment with acid or base. As opposed to pyrolysis, etching of polymer minimally affects the dimensions of the metal layers or portions. This may be used to generate hollow structures such as lightweight metal foams or lattices that possess a high strength to weight ratio.

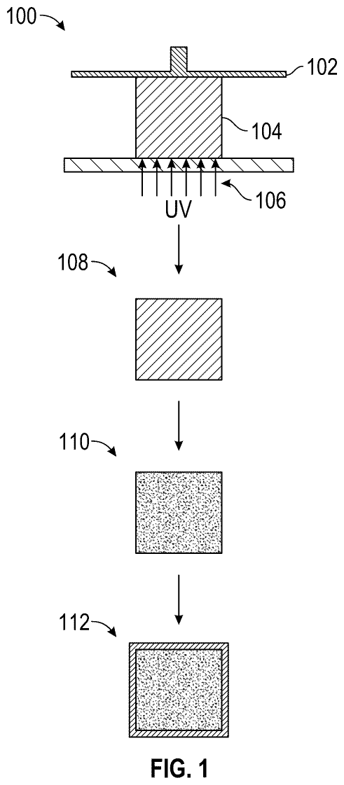

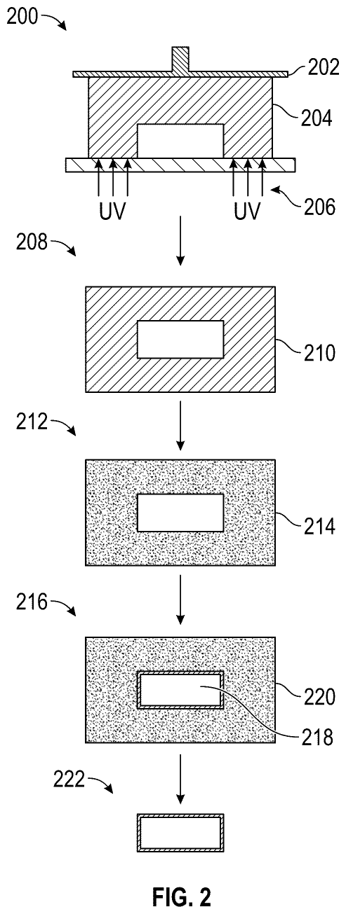

In some embodiments, the electroless plating may be performed the exterior surface of the 3D printed object. An example of this method is depicted in FIG. 1. In the first step (100), a build platform (102) is raised or lowered to change the Z-height as necessary, a patterned UV exposure (106) is used to solidify layers of photopolymer to yield a 3D shape (104). In the next step (108), the cured or partially cured 3D object is removed from the 3D printer and excess photopolymer cleaned off. The object is then further cured, and the precursors reduced to form nanoparticle catalyst sites (110) followed by electroless plating (112). In other embodiments, the surface to be plated may be on the interior of the 3D object such as a microchannel or cavity (FIG. 2). A build platform (202) is raised or lowered to change the Z-height as necessary, a patterned UV exposure (206) is used to solidify layers of photopolymer to yield a 3D shape with a cavity (204). Excess uncured resin is then cleaned off (208) followed by further curing and reducing of the catalyst precursor (210). The activated 3D object is then plated by exposing the interior surfaces of the microchannels or cavities to electroless plating solutions. The object may be optionally etched to obtain a standalone thin-walled metallic structure (212). In another embodiment, any number of interior and exterior surfaces on a 3D object may be plated as desired.

In another embodiment, metal particle-free catalyst precursor resins are shaped into a 3D form by any suitable method other than stereolithography. This may include inkjet printing, extrusion, injection molding, casting, thermoforming, filament 3D printing or any other suitable method of obtaining the desired 3D shape. In some embodiments, the metal particle-free resins are liquids or semi-liquids suitable for casting in a mold or spraying through a nozzle. In other embodiments, the metal particle-free resins are in the form of solids which may be in any form, but which are then rendered liquid or semi-liquid through any combination of heat and pressure during a 3D printing or shaping step. In one specific embodiment, the solid resin may be shaped into a filament suitable for 3D printing by fused deposition modeling (FDM) printing. One advantage of a metal-particle free filament compared with existing resins loaded with metal particles is reduced wear and tear to the nozzles due since there are minimal abrasive particles. Another advantage would be a potentially higher resolution and increased accuracy of printing shapes with fine features.

FIG. 1 is an illustration of steps involved in stereolithography 3D printing of an object using a particle-free catalyst precursor resin that is subsequently cured and catalytic nanoparticles generated in-situ. Plating the external surface of the yields a structure with a metallic exterior surface coating.

In the first step (100), a build platform (102) is raised or lowered to change the Z-height as necessary, a patterned UV exposure (106) is used to solidify layers of photopolymer to yield a 3D shape (104). In the next step (108), the cured or partially cured 3D object is removed from the 3D printer and excess photopolymer cleaned off. The object is then further cured, and the precursors reduced to form nanoparticle catalyst sites (110) followed by electroless plating (112).

FIG. 2 is an illustration of steps involved in generating a catalytic 3D printed object with an internal cavity. Plating the internal cavity can result in a metal-lined chamber. Optional etching of the polymer yields a thin-walled metallic object.

In a first step 200, a build platform (202) is raised or lowered to change the Z-height as necessary, a patterned UV exposure (206) is used to solidify layers of photopolymer to yield a 3D shape with a cavity (204). Excess uncured resin is then cleaned off (208) followed by further curing and reducing of the catalyst precursor (210). The reduction of the catalyst precursor yields nanoparticle catalyst sites (214).

The activated 3D object is then plated by exposing the interior surfaces of the microchannels or cavities to electroless plating solutions (218) to yield a polymeric object with a metal-coated interior structure (220). The object may be optionally etched to obtain a standalone thin-walled metallic structure (222). In another embodiment, any number of interior and exterior surfaces on a 3D object may be plated as desired.

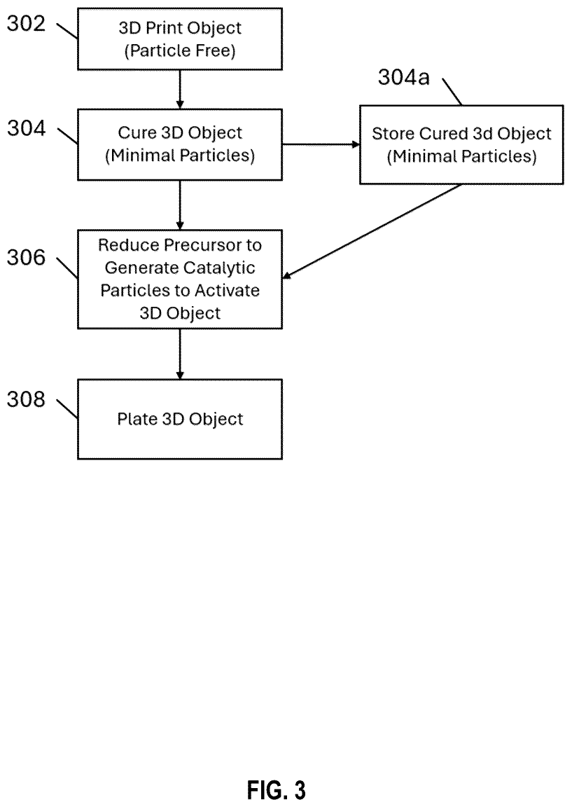

FIG. 3 is a flow chart for a method of implementing the usage of metal particle-free resins wherein catalytic particle generation step occurs separately from the resin curing step and preferably close in time to the plating step.

It is understood that the above descriptions are for the purposes of illustration and are not meant to be limiting.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HIDR) subscriber station, an access point, a printer, a point of sale device, an access terminal, or other personal communication system (PCS) device. The device may be either mobile or stationary.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method for making a 3D object including at least one conductive surface, the method comprising:
stereolithographic printing of at least part of a three-dimensional (3D) object using a metal particle-free precursor resin, wherein the resin comprises:
monomers, oligomers, or polymers,
reducible metal ions, metal complexes, or organometallics,
a photoinitiator, and
a chelating agent or a ligand;
curing the 3D object by at least partially solidifying the object;
generating catalytic nanoparticles within the object by reduction of the reducible metal ions or metal complexes, or decomposition of an organometallic; and
plating at least one surface of the 3D object using electroless plating to yield a conductive surface.

2. The method of claim 1, wherein the particle-free precursor resin comprises a reducing agent associated with generating the catalytic nanoparticles.

3. The method of claim 1, wherein a metal complex or the organometallic is a precursor that decomposes to yield the catalytic nanoparticles.

4. The method of claim 1, wherein a plating catalyst precursor comprises at least one of a silver (Ag) salt, a copper (Cu) salt, a palladium (Pd) salt, a nickel (Ni) salt, a gold (Au) salt, a platinum (Pt) salt or another source of metal ions suitable for use as an electroplating catalyst.

5. The method of claim 1, wherein additives are used to modify a property of the resin or of a 3D object made from the resin comprising hydrophilicity, viscosity, photoinitiator sensitivity, heat capacity, mechanical strength, adhesion, or biocompatibility.

6. The method of claim 1, wherein the chelating agent or the ligand comprises a group selected from one of the following: an aldimine, a pyridine, a pyrazine, a carboxylic acid, an alkyl amine, an alcohol amine, ammonia, or an aldehyde.

7. The method of claim 1, wherein the monomers, oligomers, or polymers comprise acrylates and are mixed with a photoinitiator to initiate polymerization or crosslinking of the monomers and oligomers.

8. The method of claim 7, wherein the acrylates are selected from one or more of the following: polyethylene glycol acrylates, urethane acrylates, amine acrylates, epoxy acrylates, an acrylamide, or polyester acrylates.

9. The method of claim 1, wherein one or more exterior surfaces of the 3D object are metallized with electroless plating to yield at least the conductive surface.

10. The method of claim 1, wherein one or more interior surfaces, cavities, or channels within the 3D object is metallized with electroless plating to yield at least the conductive surface.

11. The method of claim 1, wherein any number of exterior or interior surfaces is metallized with electroless plating to yield at least the conductive surface.

12. The method of claim 1, wherein a polymer-metal composite body portion of the 3D object is pyrolyzed to remove the polymer and yield an object that comprises mostly metal.

13. The method of claim 1, wherein a polymer-metal composite body portion of the 3D object is treated such that the polymer is etched or dissolved to yield a 3D conductive object with less polymer than an untreated body portion of the 3D metal object.

14. The method of claim 13, wherein a 3D metal body portion of the 3D metal object is a metal foam or metal micro-lattice.

15. A method for making a three-dimensional (3D) object including at least one conductive surface using a metal particle-free precursor resin, wherein the resin comprises:
monomers, oligomers, or polymers;
reducible metal ions, metal complexes, or organometallics; and
a chelating agent or ligand; and wherein the method comprises:
forming a 3D object consisting of a hydrogel;
generating catalytic nanoparticles within the 3D object by reduction of the metal ions or metal complexes, or decomposition of an organometallic; and
plating at least one surface of the 3D object using electroless plating to yield a conductive surface.

16. The method of claim 15, wherein the polymers are selected from a biologically derived polymer comprising alginate, gelatin, hyaluronic acid, chitosan, heparin, and fibrin.

17. The method of claim 15, wherein the polymers are selected from synthetic polymers used to make hydrogels comprising polyvinyl alcohol, polyethylene glycol, polyacrylate, polyacrylamides, polyvinylpyrrolidone and co-polymers and combinations thereof.

18. The method of claim 15, wherein the particle-free precursor resin comprises a reducing agent associated with generating the catalytic nanoparticles.

19. The method of claim 15, wherein a metal complex or organometallic is a precursor that decomposes to yield the catalytic nanoparticles.

20. A method for making a three-dimensional (3D) object including at least one conductive surface, the method comprising:
forming a 3D object using a metal-particle-free precursor resin, wherein the resin comprises:
monomers, oligomers, or polymers, and
reducible metal ions, metal complexes, or organometallics,
curing the 3D object by at least partially solidifying the object;
generating catalytic nanoparticles within the object by reduction of the reducible metal ions or metal complexes, or decomposition of an organometallic; and
plating at least one surface of the 3D object using electroless plating to yield a conductive surface.
